(19) United States
(12) Patent Application Publication
(10) Pub. No.: US 2004/0135668 A1
(43) Pub. Date: Jul. 15, 2004

(54) Closure system and method

(76) Inventors: Erik H. Hoffer, Punta Gorda, FL (US); Marilyn J. Bohmker, Redmond, OR (US)

Correspondence Address: KOLISCH HARTWELL, P.C., 520 S.W. YAMHILL STREET, SUITE 200, PORTLAND, OR, 97204, US

(21) Appl. No.: 10/692,482

(22) Filed: Oct. 24, 2003

Related U.S. Application Data
(60) Provisional application No. 60/421,313, filed on Oct. 24, 2002.

(51) Int. Cl. G06F 7/04

(52) U.S. Cl. 340/5.2; 340/5.73

(57) ABSTRACT

A closure system and method for improving cargo security. According to one aspect of the disclosure, a locking module is configured to selectively prevent unpermitted access to an enclosure. A memory module is correlated to the locking module and configured to store information corresponding to the enclosure.

### CROSS-REFERENCES

This application claims the benefit of U.S. Provisional Application No. 60/421,313, filed Oct. 24, 2002, the content of which is incorporated by reference.

### BACKGROUND

Many types of cargoes are shipped and stored in a variety of different shipping containers. Typically, shipping containers are designed to correspond with one or more modes of transportation or storage, and/or to correspond with a particular size or composition of cargo. The security of shipped and stored cargo in such containers is an ongoing problem. Theft, vandalism, and other forms of tampering can be costly and dangerous. If not properly secured and tracked, cargo can be stolen or vandalized, resulting in monetary loss. Furthermore, cargoes that are not secured and tracked can be subject to malicious tampering. If such tampering goes undetected, the affected cargoes can undesirably serve as a mechanism to deliver harm to unsuspecting individuals.

### SUMMARY

A closure system and method for improving cargo security is provided. According to one aspect of the disclosure, a locking module is configured to selectively prevent unpermitted access to an enclosure. A memory module is correlated to the locking module and configured to store information corresponding to the enclosure.

### BRIEF DESCRIPTION OF THE DRAWINGS

FIG. 1 is a block diagram showing a closure system according to the present description.

FIG. 2 shows an exemplary closure system including a memory module that is physically coupled to a locking module.

FIG. 3 shows the closure system of FIG. 2 securing a container.

FIG. 4 shows another exemplary closure system including a memory module that is physically coupled to a locking module.

FIG. 5 is a cross-section view of a portion of the memory module, as indicated in FIG. 4.

FIG. 6 is a circuit schematic of the memory module of FIG. 4.

### DETAILED DESCRIPTION

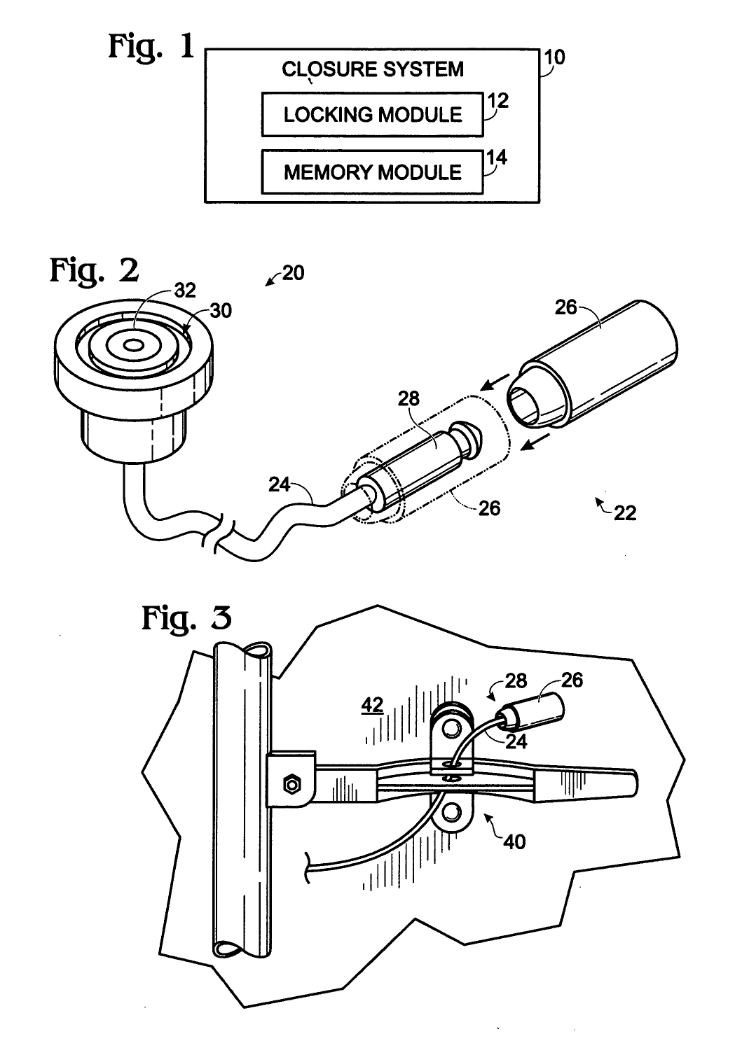

FIG. 1 schematically shows a closure system 10 including a locking module 12 and a correlated memory module 14. Locking module 12 of closure system 10 may be configured to selectively prevent access to the contents of an enclosure. In other words, the locking module may effectively lock an enclosure to prevent theft and/or tampering of the contents of the enclosure. As used herein, “enclosure” refers to any freight container, rail container, storage container, truck, trailer, box, tote, cabinet, pallet, etc., which may be used for moving and/or storing cargos of varying sizes and compositions. Closure systems according to the present description may be configured to prevent unrestricted access to the contents of such enclosures. For example, access may be prevented by locking contents within an enclosure, such as a freight container, and/or by locking contents to an enclosure, such as a palette.

As mentioned above, closure systems according to the present description may be configured to service a variety of different types of enclosures. As a result, locking modules of such closure systems may take a variety of forms, which are complementarily configured to effectively prevent access to such enclosures. Nonlimiting examples of suitable locking modules include locking bars, locking cables, locking seals, padlocks, etc. U.S. Pat. Nos. 5,775,747; D351,984; D351,985; and D399,118; which are hereby incorporated by reference, include nonlimiting examples of suitable locking modules. It should be understood that other locking modules may additionally or alternatively be used. It is within the scope of this description to correlate a memory module to virtually any locking module that selectively prevents, or at least limits, access to the contents of an enclosure. The particular method of correlating a memory module to a locking module may vary according to the configuration of the locking module, which is typically designed to service a particular type of enclosure.

Locking module 12 may include a single-use locking mechanism or a plural-use locking mechanism. A plural-use locking mechanism may be configured to be opened by a keying mechanism. A keying mechanism may utilize a physical key, electronic key, magnetic key, optical key, mechanical combination, electronic combination, etc. For example, the lock may include a physical keyhole, into which a key may be inserted to unlock (or lock) the lock, a keypad for entering a combination, or a scanner configured to read an access key from a key card. A one-time lock may selectively be locked a single time. Both single-use and plural-use locking modules are configured to be easily applied to a locking structure, such as a locking structure found on a freight container and/or other enclosure. Once in a locked configuration, the closure system typically cannot be unlocked without a keying mechanism specifically designed to unlock the locking module or without destroying the closure system. A single-use locking module may be unlocked according to a specific procedure, such as cutting a portion of the closure system. However, a single-use locking module may not be subsequently relocked.

Closure system 10 includes a memory module 14. Memory module 14 may include one or more memory portions configured to store information in the form of digital data. The memory module may include nonvolatile memory portions and/or volatile memory portions. A memory module with a relatively small form factor is particularly well suited for use in closure system 10. It is within the scope of this description to utilize a variety of memory technologies, including semiconductor memory, magnetic storage media, optical storage media, and/or other volatile or nonvolatile memory. As used herein, “stored” means that information is at least temporarily placed in memory for retrieval at a later time. Stored information may be permanently stored or temporarily stored. Temporarily stored information may be subsequently erased or overwritten with other information. Information may be stored in a desired format, with or without compression and/or encryption.

Memory module 14 may be equipped with an interface for accessing data stored in the memory, such as to add data to memory, retrieve data from memory, overwrite data in memory, erase memory, etc. In some embodiments, the interface may include one or more electrical contacts, through which a signal may pass. Such contacts may be arranged to cooperate with a complementary interface of another device, which may be used to access information stored in the memory module. Other interfaces may alternatively or additionally be used. For example, in some embodiments, the memory module may include a wireless, or contactless, interface providing access to stored information.

In some embodiments, the memory module may store information corresponding to the enclosure serviced by closure system 10. For example, the memory module may store a digital manifest for the enclosure, a digital image of contents of the enclosure, machinery maintenance records for the enclosure and/or a vehicle or other device used to ship the enclosure, retail tagging, inventory control, and/or a locking signature. A locking signature may effectively be used to monitor a closure system. A locking signature may include one or more types of information, such as when the locking module was unlocked, who unlocked the locking module, what key was used to unlock the locking module, where the locking module was unlocked, etc. The locking signature provides information regarding access to the contents of an enclosure. Therefore, a locking signature may be used to monitor the contents of an enclosure, thereby limiting the danger of unauthorized access, tampering, and/or theft, or at least assisting in the detection of unauthorized access, tampering, and/or theft.

A closure system that includes a memory module that is physically coupled to a locking module facilitates inspection of the contents of the memory at the same time the lock is inspected and/or manipulated (i.e. locked or unlocked). The memory module may be permanently linked to the locking module, and therefore travels with the cargo the locking module is protecting. Furthermore, integrating locking and memory functions into a single device may increase the likelihood of detecting tampering of the lock. The closure system may replace (or supplement) paperwork, which can be tampered with and/or replaced independent of a lock. In some embodiments, operation of the locking module (i.e. locking and unlocking) may alter information stored in the memory module. For example, the memory module may automatically store the time at which the locking module is locked and/or unlocked, thereby further facilitating assessment of the contents of the container protected by the locking module, including assessment of potential breaches of the security provided by the locking module.

As mentioned above, a closure system 10 may be configured to correspond to a particular type of enclosure. The following embodiments are provided as nonlimiting examples of closure systems within the scope of the present description. It should be understood that other closure systems are also within the scope of the present description. Furthermore, it should be understood that the methods of correlating a locking module to a memory module are provided as nonlimiting examples, and other methods may be used.

FIG. 2 shows a closure system 20 that includes a locking module 22 that includes a cable 24 and a locking head 26. Closure system 20 also includes a memory module 30 that includes a memory button 32. Memory module 30 is physically coupled to cable 24. In the illustrated embodiment, the memory module is permanently attached to the cable, meaning that the memory module is not configured to be selectively separated from the cable. Locking head 26 may engage a locking end 28 of cable 24 so that the locking head is fixed to the locking end of the cable, as indicated in dashed lines. For example, locking head 26 may engage a locking end 28 that has been threaded through an opening so that the locking end cannot be removed from the opening. For example, FIG. 3 shows locking end 28 of cable 24 threaded through a locking structure 40 of an enclosure 42. Locking head 26 is engaging locking end 28. Because the locking head (and the memory module) is larger than the opening of locking structure 40 through which the locking end is threaded, cable 24 cannot be removed from the locking structure. Cable 24 effectively prevents locking structure 40 from opening, thus preventing unauthorized access to the contents of enclosure 42. In the illustrated embodiment, the closure system is a single-use item; in other words, the locking head is not configured to be repeatedly locked and unlocked to the locking end of the cable.

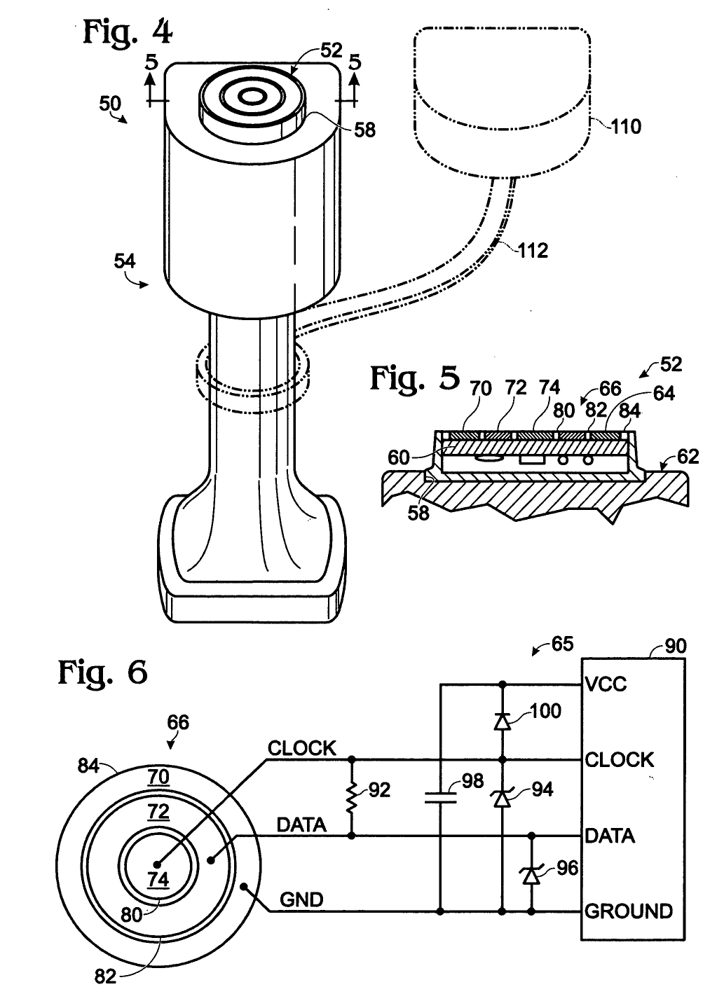

FIG. 4 shows another closure system 50, which includes a memory module 52 physically coupled to a locking module 54. As illustrated, locking module 54 provides a housing for the memory module. The locking module includes an internal bore 58 wherein the memory module may be set. In the illustrated embodiment, the bore diameter is approximately 0.64-inches, and the depth of the bore is on the order of approximately 0.20-inches. In other embodiments, a bore may be differently sized to accommodate a memory module having a different size. Similarly, placing a memory module in a bore of a locking module is a nonlimiting example of a coupling arrangement, and other arrangements may be used.

As schematically shown in FIG. 5, memory module 52 includes a circuit that is mounted on a rigid, generally planar printed circuit board 60. The memory module may be formed to fit somewhat closely within bore 58. The memory module may be raised from a surface 62 of locking module 54, thus exposing a first side 64 of the memory module. In other embodiments, the memory module may be recessed or lie flush with the surface of the locking module. The first side of the memory module may include an interface 66, which can be used to access information stored in the memory module. As a nonlimiting example, the illustrated embodiment has an interface that includes conductive concentric circles 70, 72, and 74. The conductive circles may be electrically isolated from each other, and from the locking module itself, to provide first, second and third distinct electrical contact surfaces. The memory module may include nonconductive insulation circles 80, 82, 84 that facilitate in isolating the conductive circles. One or more of the insulating circles may be defined by circuit board etching, and one or more insulating circles may be defined by nonconductive potting material, which may also serve as an adhesive to secure the memory module within the bore. Through-hole vias can be used to electronically connect the conductive circles to components mounted on the printed circuit board.

As indicated above, potting material may be used to hold the memory module in place. Such potting material may be poured into bore 58 and then covered by the memory module. In some embodiments, components of the printed circuit board face downwardly into the bore and thus are electrically isolated by the potting material. The memory module may be pushed down until it is firmly seated. As mentioned above, a memory module may be raised above, recessed beneath, or lie flush with a surface of the closure system. Accordingly, such closure systems may have relatively deep bores or relatively shallow bores, including embodiments with no bore whatsoever. When potting material is used, excess potting material may pass between the circuit board and a perimeter of the bore, where it can subsequently be wiped away. In some embodiments, a locking module may be molded, or otherwise formed, around a memory module. In such embodiments, a potting material, or other adhesive may also be used, although such use is not required.

As schematically illustrated in FIG. 6, the memory module may include a circuit 65 in electrical communication with interface 66. Circuit 65 may be arranged on a memory module, such as by mounting circuit components on a back side of a circuit board. In the illustrated embodiment, circuit 65 includes a nonvolatile semiconductor memory 90, and several discrete components electrically connected thereto. In one exemplary embodiment, memory device 90 may take the form of a Microchip 24LC02, resistor 92 may have a resistance of 47 K ohms, zener diode 94 and zener diode 96 may be part number 1N5233B diodes, capacitor 98 may have a capacitance of 0.22 uF, and rectifier diode 100 may be a part number 1N4001 diode.

A memory module and an external device may be complementarily configured so that the external device can read data from and/or write data to the memory module. Such an external device may be referred to as a wand. An interface of a wand may be aligned with an interface of the memory module, so that information may be transferred between the wand and the memory module. In some embodiments, the wand may connect to the data module using a plurality of pins which are configured to engage electrical contacts 70, 72, and 74. The wand may include a microprocessor, such microprocessor being configured to read data from the module and/or write data to the module via a circuit which includes clock signal lines and data signal lines. Such clock and data lines connect the memory module's contacts respectively to clock and data pins. Similarly, a ground line connects the remaining contact to a ground pin of the wand. In some embodiments the wand may include a user interface for controlling the memory and reporting information to a user, and in some embodiments, the wand may act as a peripheral to another device configured to control operation of the wand. A more particular description of an exemplary device configured to access a memory module is provided in U.S. Pat. No. 5,506,757, which is commonly owned herewith, and which is herein incorporated by reference.

To communicate with a memory module, a wand may use a modified version of a Phillips Electronics I squared C (IIC) bus. Full documentation of a conventional IIC bus is available from Phillips Electronics. Such a modified bus may operate similarly to a conventional IIC bus, but without some of the conventional bus's limitations. For example, clock and data lines may be used to power a memory module using a modified bus, consequently, a separate power line is not required when using a modified bus. Furthermore, whereas a conventional IIC bus limits bus capacitance to 400 pF on the clock and data lines, a modified bus may not be so limiting. Similarly, whereas a conventional IIC bus limits the maximum high level input current at 90% Vdd for both clock and data pins to 10 uA, the modified bus does not share this limitation. Finally, the bus clock is limited to 100 kHz on a conventional IIC bus, but not on a modified bus. A memory module of the present description can use a bus clock greater than 100 kHz, therefore, a modified bus improves compatibility with such memory modules. It should be understood that specific componentry of a memory module and/or wand may vary. In general, the memory module and the wand are configured to cooperate with one another, regardless of the specific componentry selected to embody the memory module and the wand.

A wand can power and communicate with a memory module using two signal lines via a modified bus. These signal lines are designated CLOCK and DATA in FIG. 6. The wand may be configured with a low impedance source driver with a pull down resistor on the clock line. The clock line thus can provide sufficient current, while in a high state, to power the memory module and also charge a capacitor, or similar device, in the memory module. When the clock line is in a low state, the electronic data module can draw power from the onboard capacitor that was charged during the high state.

FIG. 4 shows a cover 110, configured to protect memory module 52. As indicated, cover 110 may be secured to locking module 54 via a leash 112. Cap 110 may be temporarily secured over memory module 52, so that the memory module is shielded from potential damage. The cover may be held in place by frictional, magnetic, and/or mechanical force.

As described above, in some embodiments, a locking module may be correlated to a memory module via physical coupling, which may be permanent. In some embodiments, a locking module may be correlated to a memory module via a common identifier, such as a number or other indicia. For example a memory module may store a number, which may also be printed on a locking module. The number may be read from memory and compared to the number on the locking module to ensure that the memory module has not been undesirably replaced. As mentioned above, such a number, as well as other information, may be encrypted so as to increase security. In some embodiments, a locking module that is not physically coupled to a memory module may be correlated to the memory module via a common identifier. A common identifier may be printed on the locking module, or otherwise permanently associated with the locking module, while a corresponding identifier is stored in the memory module and/or otherwise associated with the memory module. In this manner, memory modules that are not physically linked to a locking module may still be determinably correlated, so that information stored within the memory module can directly correspond to the locking module, the enclosure, and/or the contents of the enclosure of which the locking module is protecting.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

What is claimed is:

1. A method of providing cargo security, comprising:
providing a closure system that includes a memory module and a locking module, wherein the memory module is fixed to the locking module;
loading into the memory module information corresponding to an enclosure; and
locking the enclosure with the locking module.

2. The method of claim 1, wherein loading into the memory module information corresponding to the enclosure includes loading a manifest for the enclosure.

3. The method of claim 1, wherein loading into the memory module information corresponding to the enclosure includes loading a digital image of contents of the enclosure.

4. The method of claim 1, wherein loading into the memory module information corresponding to the enclosure includes loading a locking signature.

5. The method of claim 4, wherein the locking signature includes when the enclosure was unlocked.

6. The method of claim 4, wherein the locking signature includes who unlocked the enclosure.

7. The method of claim 4, wherein the locking signature includes where the enclosure was unlocked.

8. The method of claim 1, further comprising reading from the memory module the information corresponding to the enclosure while the locking module is locking the enclosure.

9. A closure system, comprising:
a locking module configured to selectively prevent unpermitted access to an enclosure; and
a memory module correlated to the locking module and configured to store information corresponding to the enclosure.

10. The closure system of claim 9, wherein the memory module is correlated to the locking module via a common identifier.

11. The closure system of claim 9, wherein the memory module is correlated to the locking module via physical coupling.

12. A closure system, comprising:
a locking module configured to selectively prevent unpermitted access to an enclosure; and
a memory module coupled to the locking module and configured to store information corresponding to the enclosure.

13. The closure system of claim 12, wherein the memory module is permanently coupled to the locking module.

14. The closure system of claim 13, wherein the memory module is embedded in the locking module.

15. The closure system of claim 13, wherein the memory module is glued to the locking module.

16. The closure system of claim 13, wherein the locking module defines a bore holding a potting material, and wherein the memory module is set in the potting material.

17. The closure system of claim 12, wherein the locking module includes a keying mechanism configured to selectively provide access to the enclosure.

18. The closure system of claim 12, wherein the locking module includes a locking bar.

19. The closure system of claim 12, wherein the locking module includes a locking cable.

20. The closure system of claim 12, wherein the locking module includes a locking seal.

21. The closure system of claim 12, wherein the locking module includes a padlock.

22. The closure system of claim 12, wherein the memory module includes a nonvolatile memory.

23. The closure system of claim 12, wherein the memory module digitally stores information corresponding to the enclosure.

24. The closure system of claim 12, wherein the memory module stores a manifest for the enclosure.

25. The closure system of claim 12, wherein the memory module stores a digital image of contents of the enclosure.

26. The closure system of claim 12, wherein the memory module stores a locking signature.

27. The closure system of claim 26, wherein the locking signature includes when the enclosure was unlocked.

28. The closure system of claim 26, wherein the locking signature includes who unlocked the enclosure.

29. The closure system of claim 26, wherein the locking signature includes where the enclosure was unlocked.

30. The closure system of claim 12, wherein the enclosure is a freight container.

31. The closure system of claim 12, wherein the memory module includes an interface having a plurality of electrically conductive contact surfaces.

32. The closure system of claim 31, wherein the contact surfaces are concentrically arranged.

33. The closure system of claim 31, wherein the memory module is configured to be selectively powered via the contact surfaces.

34. The closure system of claim 31, wherein the memory module includes clock and data pins, and wherein the contact surfaces are electrically coupled to the clock and data pins.

35. The closure system of claim 34, wherein the memory module is configured to be selectively powered via the clock and data pins.

36. The closure system of claim 12, further comprising a cap configured to cover the memory module.

37. The closure system of claim 36, wherein the cap is secured to the locking module via a leash.

38. A closure system, comprising:
a locking module configured to selectively prevent access to an enclosure, wherein the locking module includes a body defining an internal bore;
a nonvolatile memory device;
a generally planar circuit board having a first side with a plurality of electrically conductive contact surfaces, and a second side which mounts the nonvolatile memory device in a determined electrical relation with the contact surfaces;
wherein the circuit board and the nonvolatile memory device are installed within the internal bore such that the contact surfaces are substantially exposed for electrical access of the nonvolatile memory device.

39. The closure system of claim 38, wherein the contact surfaces are concentrically arranged.

40. The closure system of claim 38, wherein the nonvolatile memory device is selectively powered via the contact surfaces.

41. The closure system of claim 38, wherein the contact surfaces connect to clock and data pins of the nonvolatile memory device.

42. The closure system of claim 41, wherein the nonvolatile memory device is selectively powered via clock and data input lines.

43. The closure system of claim 38, wherein the bore holds a potting material, the second side of the circuit board being set in the potting material.

44. The closure system of claim 38, further comprising a cap configured to cover the circuit board.
